(19) United States
(12) Patent Application Publication
(10) Pub. No.: US 2005/0281927 A1
(43) Pub. Date: Dec. 22, 2005

(54) Citrus paper application sheet for applying to freshly exposed or cut surfaces of fruit to prevent browning

(76) Inventor: Kathleen A. Lappe, Bowling Green, KY (US)

Correspondence Address: KATHLEEN ABIGAIL LAPPE, 329 REDBIRD TRAIL, BOWLING GREEN, KY, 42101, US

(21) Appl. No.: 11/209,488

(22) Filed: Aug. 23, 2005

Related U.S. Application Data
(63) Continuation-in-part of application No. 10/356,212, filed on Jan. 31, 2003, now abandoned.

(51) Int. Cl. C12H 1/10

(52) U.S. Cl. 426/323

(57) ABSTRACT

A preservative paper of weighting 25-40 lbs or 90-150 grams per sq. meter uncoated, acid-free, laser printing paper, with bond strength of an interlayer binding force, soaked for at least five (5) minutes in sufficient acid constituents, then dried for at least one (1) hour prior to use for applying to exposed or cut surfaces of fruit or vegetables that discolor, lose flavor and/or nutrients after cutting, as well as, create a much needed barrier against any unwanted matter, such as bugs, dirt or pathogens from invading the freshly exposed or cut portion of fruit or vegetable and is intended to be an end-user product or household product to be used at home as needed.

### CROSS-REFERENCE TO RELATED APPLICATION

This is a continuation in part of application Ser. No. 10/356,212

### FIELD OF THE INVENTION

The field of this invention relates to a method of preserving fresh fruit or vegetables which discolor, lose flavor and/or nutrients after cutting, as well as, create a much needed barrier against any unwanted matter, such as bugs, dirt or pathogens from invading the freshly exposed or cut portion of fruit or vegetable and is intended to be an end-used product or household product to be used as needed.

### BACKGROUND OF THE INVENTION

The average family's yearly consumption of food often results in large quantities of wasted edible fruit. When half of a banana or part of an apple is eaten, browning usually occurs on the uneaten portion, which is often times then discarded. Currently, there is no method known in the art or option for the consumer to preserve and protect their cut fruit at home. In addition, the convenience of having ready-made preservative paper strips on hand in an easily accessible distribution box, to apply immediately apply on the uneaten exposed parts of fruit to prevent browning and to protect it from unwanted matter, such as bugs, dirt or pathogens, is an extremely valuable product that has not yet been introduced to the public.

Preservative strips describe during manufacturing, must be put in sufficient acid constituents solution of citric acid and/or ascorbic acid for more than five (5) minutes or longer for proper permeation. After soaking in the acid constituents solution for more than five (5) minutes, the preservative strips are then removed, dried and cut into the specific sizes and packaged for shelving or sale. The preservative paper can than be applied to any uneaten portion of fruit or

vegetable to preserve, keep from browning and protect for future consumption, therefore reducing large quantities of wasted fruit and protecting the consumers health, as well as, saving the consumer money.

With a shelf-life of over a year, this product is also inexpensive to manufacture, making it much more cost effective for the general consumer, a person that can only afford to buy whole fruit as opposed to the high-priced pre-cut bagged preservative fruit.

The preservative paper strips, on the other hand, can be used on an as-needed basis and does not require refrigeration after application. The preservative strips are also extremely effective on cut end fingers of bananas and last the life of the banana.

The specific paper type consisting of 25-40 lb wt. or 90-150 grams per sq. meter, uncoated, acid-free, laser printing paper, with bond strength of an interlayer binding force is the key to achieving the desired results. A lighter paper, such as below 25 lb bond paper, toilet paper, paper towel or woven fabric would be too fragile and/or porous. A heavier paper, such as above 40 lb bond paper, heavy card stock paper and card board would be too hard and/or stiff. The specific preservative strip of 25-40 lb wt. or 90-150 grams per sq. meter, described above, is as close to putting the skin back on the fruit as is possible without actually doing so.

The preservative agents; sodium benzoate, sodium metabisulfite and sodium sulfite are a necessary addition for the shelf life of the acid constituents before the manufacturing process. The removal of the micro-biocides process from the paper is necessary to make the paper food grade.

ABSTRACTED-PUB-NO: DE 3717862A, Inventor: Stephan J. discloses the fresh fruit salads—comprised of fruit cubes coated with fruit juice in an airtight package. Although the bagged preserved fruit may be effective. The long term usability is not convenient, as it must be consumed in a timely manner as the fruit is already cut. Also, vacuum packaging generally creates an-aerobic conditions which are conductive fermentation, often resulting in distorted flavors and promote growth of pathogenic organisms.

Japanese patent abstract publication: 10-113120, Inventor: Mishima Toshihiro, discloses the use of sulfates, which are a combination of sulfur compounds that combine sulfur with amino acid, sulfate, sulfite, and thioshifate. Sulfates are known to cause adverse health effects, especially in asthmatics. They can also negatively affect the taste of food. FDA prohibits the use of sulfites on fresh produce intended to be sold or served raw to consumers, and because sulfites destroy thiamin (vitamin B1), the FDA also prohibits the use of sulfites in foods that are important sources of this nutrient, such as enriched flour. Also, the paper or various kinds of web material mentioned are limited and fail to list a specific formula as to what specific type of paper would be effective.

JP402291226A describes a technique of coating cutlery, a wrapping sheet to the exposed portions of fruit with an edible jelly material. This composition suffers from the disadvantage of having a slippery or slimy texture. It may be acceptable for salads which are covered in fruit juice but not for fruit intended to be eaten with fingers rather than a spoon. Also, the wrapping sheet mentioned is limited, by having no specific formula as to what specific type of paper would be effective.

JP409077603 describes the use of Kojic acid [5-hydroxy-2-(hydroxymethyl)-gamma-pyrone], a fungal metabolite that has been shown to be a PPO inhibitor, acting by interfering with oxygen uptake and reducing o-quinones to diphenols to prevent pigment formation (Chen et al., 1991). Whether this compound shows potential as a practical browning, kojic acid is a fungal metabolite commonly produced by many species of aspergillus, acetobacter and penicillium. The aspergillus flavus group has traditionally been used in the production of a number of foods, including miso (soybean paste), shoyu (soy sauce), and sake. Kojic acid is widely used as a food additive for preventing enzymatic browning and in cosmetic preparations as a skin-lightening or bleaching agent. Because kojic acid is often produced during the fermentation of historically used dietary staples, it has a long history of consumption. Various types of compounds, such as glucose, sucrose, acetate, ethanol, arabinose and xylose, have been used as carbon sources for kojic acid production. Different aspergillus species are known to produce variable amounts of kojic acid. The mechanism of action of kojic acid is well defined and has been shown to act as a competitive and reversible inhibitor of animal and plant polyphenol oxidases, xanthine oxidase, D-amino and some L-amino acid oxidases. The structure of kojic acid indicates a relatively simple route of metabolism much like dietary hexoses. Acute or sub chronic toxicity resulting from an oral dose has not been reported, but convulsions may occur if kojic acid is injected. Results of mutagenicity studies are mixed, but in the in vivo mammalian dominant lethal assay, kojic acid was proven negative. Continuous administration of high doses of kojic acid in mice resulted in induction of thyroid adenomas in both sexes. Kojic acid reversibly affects thyroid function primarily by inhibiting iodine uptake, leading to decreases in T3 and T4 and increase in TSH. Increased TSH from pituitary gland in turn stimulates thyroid hyperplasia. Several lines of evidence indicate that the proliferative effects of kojic acid on thyroid are not related to a genotoxic pathway. The risk of functional inhibition of iodine uptake and its metabolism (organification) and thyroid tumor induction by kojic acid in humans appears to be extremely low. Based on the literature reviewed and discussed here, consumption of kojic acid at levels normally found in food does not present a concern for safety. Copyright 2001 Academic Press.

The Kojic acid normally used in cosmetics would seem to be undesirable in its limited FDA research and current finding to the consumer for consumption. Also, the water absorbent paper of non-woven fabric mentioned is limited to having no specific formula as to what specific type of paper would be effective.

### A DETAILED DESCRIPTION OF THE INVENTION

This invention will now be described with reference to the following tests. These tests should not be assumed to limit the claims of this invention.

The object of this experiment was to determine the importance of specifying a paper type to be used in the invention, and that generalization is not acceptable. The specific type as specified in the invention for the preservative paper is a weight of 25-40 lbs or 90-150 grams per sq. meter uncoated, acid-free, laser printing paper, with bond strength of an interlayer binding force, combined with sufficient acid constituents.

Table 1.3 and 1.5-8″ by 11.5″ sheets of paper soaked in a tray of one-hundred percent (100%) lemon citric juice and preservative agents; sodium benzoate, sodium metabisulfite and sodium sulfite for five (5) minutes, then removed and placed on a drying rack till dry.

Table 1.4 and 1.6-8″ by 11.5″ sheets of paper soaked in a tray of, one-hundred percent (100%) lemon citric juice and preservative agents; sodium benzoate, sodium metabisulfite and sodium sulfite for fifteen (15) minutes, then removed and placed on a drying rack till dry.

Table 1.6 Other paper (sizes varied upon what was available) soaked in a tray of, one-hundred percent (100%) lemon citric juice and preservative agents; sodium benzoate, sodium metabisulfite and sodium sulfite for fifteen (15) minutes, then removed and placed on a drying rack till dry.

Once all the papers were dry, they were cut into three (3) inch squares for apples and two (2) inch squares for bananas.

A scoring system described in Table 1.1 was used to subjectively assess the visual acceptability of fresh cut apple pieces. End of use life corresponds with a visual score of five (5).

TABLE 1.1

| SCORE | Definition |
|---|---|
| 0-1 | No browning. |
| 2-3 | Slight loss of color, no browning. |
| 3-4 | Slight browning, slight drying appearance. |
| 4-6 | Medium browning, also dry appearance. |
| 6-7 | ⅔ browned, also dry appearance. |
| 8-9 | ¾ of the whole browned, also dry appearance. |
| 10 | Whole piece browned. |

Table 1.2 was used to asses the incidentals that affect the overall test types such as; (ta)—Unable to prevent Tearing during Application; indicating that the paper in use is to fragile, (tm)—unable to prevent Tearing during Manufacturing; indicating that the paper in use is to fragile for the manufacturing, (s)—unable to remove Stuck; indication that the paper sticks to the fruit making it uneatable, (fe)—unable to keep on fruit Fell off; the paper is too stiff unable to bend or adhere for proper use, (u)—ugly, manufacturing process significantly changed the paper's facade; the paper has turned brown, rippled or bubbled, NA—not able to test; specifically for the card board, it was too stiff and thick to adhere properly to the apples and immediately fell off, failing the test before it had a chance to begin, (A)—Acceptable, score is under five (5), and (U)—Unacceptable, score is five (5) or greater.

TABLE 1.2
SYMBOLS

(ta) = unable to prevent tearing during application.
(tm) = unable to prevent tearing during manufacturing.
(s) = unable to remove, stuck to fruit.
(fe) = unable to keep on fruit, fell off.
(u) = ugly, manufacturing process significantly changed the paper's
façade.
(A) = Acceptable, score is under five (5).
(U) = Unacceptable, score is five (5) or greater.
NA = Not able to test.

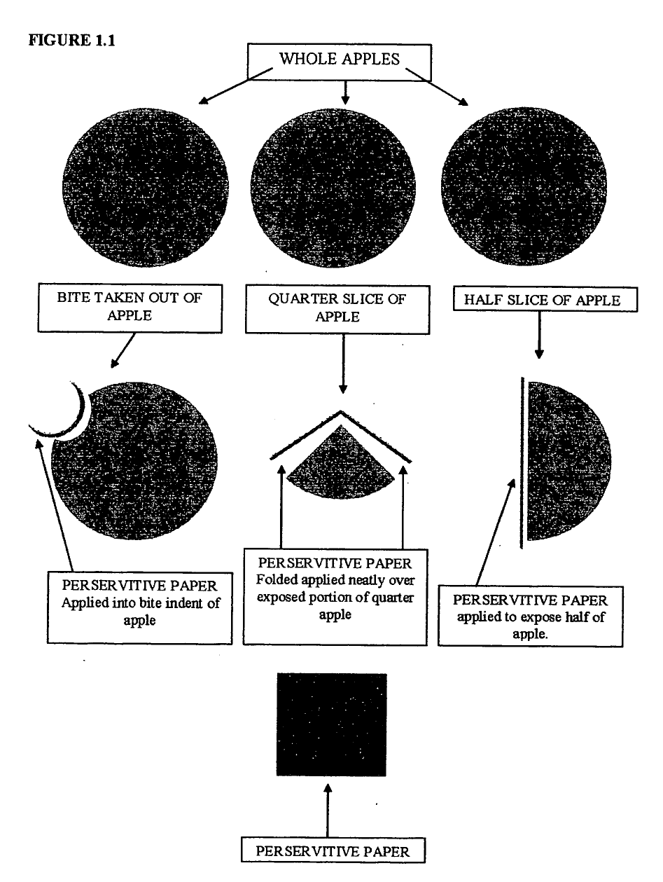

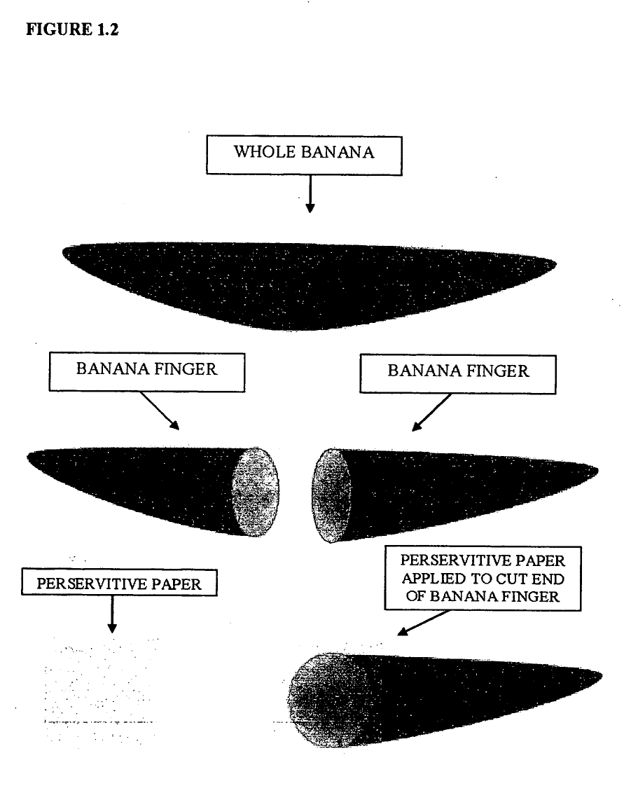

Apples (red delicious and granny smith) in tables 1.3 and 1.4 were sliced longitudinally into four (4) quarters. Since there was a total of thirteen (13) different test types, each test type was allotted one (1) quarter red delicious and one (1) quarter granny smith. See FIG. 1.1.

Bananas in table 1.5 and 1.6 were sliced in half making two fingers. Since there was a total of thirteen (13) different test types, each test type was allotted one (1) finger per test type. See FIG. 1.2.

The dry preservative papers cut into three (3) inch squares, were quickly dampened then applied to the allotted apple quarters and banana finger ends, then placed on a specified plate labeled by test type and soak time, in a line on a table for timed observation. The room temperature was on a controlled seventy-three (73) degrees with moderate humidity, normal in any given household.

Results and Discussion

Table 1.3 below summarizes the resultant scores of the fresh cut apple samples subjected to the various test types of paper previously soaked during manufacturing for five (5) minutes only, giving results over an eighteen (18) hour time lap. The result scale of four and a half (4.5) or greater can be considered unacceptable as marked with the symbols (AU) OR (U). The result scale of four (4) or less can be considered acceptable as marked with the symbol (A).

TABLE 1.3
Apples
Soaked for five (5) minutes during manufacturing

| BOND PAPER - test type | 1:30 pm | 3:30 pm | | 5:30 pm | | 7:30 pm | | 930 pm | 9:30 am |
|---|---|---|---|---|---|---|---|---|---|
| 25 lb Premium laser | 0 Scale | 1 | (A) | 1.5 | (A) | 3 | (A) | 5 (U) | 7 (U) |
| 32 lb Laser jet | 0 | .5 | (A) | 1 | (A) | 1.5 | (A) | 3 (U) | 4 (A) |
| 21 lb Multi-purpose | 0 | 1.5 | (A) | 3.5 | (A) | 5 | (U) | 7 (U) | 7 (U) |
| 20 lb Food-grade, standard (tm) | 0 | 2 | (A) | 4 | (A) | 6 | (U) | 7 (U) | 8 (U) |

Table 1.4 below summarizes the resultant scores of the fresh cut apple samples subjected to the various test types of paper previously soaked during manufacturing for fifteen (15) minutes only, giving results over an eighteen (18) hour time lap. The result scale of four and a half (4.5) or greater can be considered unacceptable as marked with the symbols (AU) OR (U). The result scale of four (4) or less can be considered acceptable as marked with the symbol (A).

Table 1.4 shows a marked improvement from table 1.3 from unacceptable to acceptable, the only difference between the tests being the soak time during the manufacturing process, which was increased by ten (10) minutes.

TABLE 1.4
Apples
Soaked for fifteen (15) minutes during manufacturing

| | 1:30 pm | 3:30 pm | | 5:30 pm | | 7:30 pm | | 9:30 pm | | 9:30 am | |
|---|---|---|---|---|---|---|---|---|---|---|---|
| BOND PAPER - test type | | | | | | | | | | | |
| 25 lb Premium laser | 0 Scale | .5 | (A) | 1 | (A) | 2 | (A) | 3 | (A) | 4 | (A) |
| 32 lb LaserJet, bond | 0 | .5 | (A) | 1 | (A) | 2 | (A) | 2 | (A) | 3 | (A) |
| 21 lb Multi-purpose | 0 | 1 | (A) | 2 | (A) | 2.5 | (A) | 3 | (A) | 4 | (A) |
| 20 lb Food-grade, standard | 0 | 1 | (A) | 2 | (A) | 3 | (A) | 5 | (U) | 6 | (U) |
| (tm) | | | | | | | | | | | |
| OTHER TYPES OF PAPER | | | | | | | | | | | |
| Toilet paper, Nice n' Soft | 0 Scale | 4 | (A) | 7 | (U) | 8.5 | (U) | 9.5 | (U) | 10 | (U)(s) |
| (tm, u) | | | | | | | | | | | |
| Card stock, premium (tm, u) | 0 | 3 | (A) | 5 | (U) | 6 | (U) | 7 | (U) | 8 | (U) |
| Handi Wipe - web woven | 0 | 2 | (A) | 5 | (U) | 8 | (U) | 9 | (U) | 10 | (U) |
| fabric (u) | | | | | | | | | | | |
| Paper towel, Brawny (u) | 0 | 2 | (A) | 4.5 | (AU) | 7 | (U) | 9 | (U) | 9 | (U) |

| | | | | | | |
|---|---|---|---|---|---|---|
| Card board, backing (fe) | 0 | NA | — | — | — | — |

Table 1.5 below summarizes the resultant scores of the fresh banana fingers samples subjected to the various test types of paper previously soaked during manufacturing for five (5) minutes only, giving results over an eighteen (18) hour time lap. The result scale of four and a half (4.5) or greater can be considered unacceptable as marked with the symbols (AU) OR (U). The result scale of four (4) or less can be considered acceptable as marked with the symbol (A).

TABLE 1.5
Bananas
Soaked for five (5) minutes during manufacturing

| BOND PAPER | 1:30 pm | 3:30 pm | | 5:30 pm | | 7:30 pm | | 930 pm | | 9:30 am |
|---|---|---|---|---|---|---|---|---|---|---|
| 25 lb Premium laser | 0 Scale | 1 | (A) | 1.5 | (A) | 2 | (A) | 3 | (A) | 4 (A) |
| 32 lb LaserJet, bond | 0 | .5 | (A) | .5 | (A) | 1 | (A) | 1 | (A) | 2 (A) |
| 21 lb Multi-purpose | 0 | 3 | (A) | 4 | (A) | 4.5 | (AU) | 5 | (U) | 6 (U) |
| 20 lb Food-grade, standard | 0 | 3 | (A) | 4.5 | (AU) | 5 | (U) | 5.5 | (U) | 7 (U) |
| (tm) | | | | | | | | | | |

Table 1.6 below summarizes the resultant scores of the fresh banana fingers samples subjected to the various test types of paper previously soaked during manufacturing for fifteen (15) minutes only, giving results over an 18 hour time lap. The result scale of four and a half (4.5) or greater can be considered unacceptable as marked with the symbols (AU) OR (U). The result scale of four (4) or less can be considered acceptable as marked with the symbol (A).

Table 1.6 shows a marked improvement from Table 1.5 from unacceptable to acceptable, the only difference between the tests being the soak time during the manufacturing process, which was increased by ten (10) minutes.

TABLE 1.6
Bananas
Soaked for fifteen (15) minutes during manufacturing

| | 1:30 pm | 3:30 pm | | 5:30 pm | 7:30 pm | 9:30 pm | 9:30 am | |
|---|---|---|---|---|---|---|---|---|
| BOND PAPER | | | | | | | | |
| 25 lb Premium laser | 0 Scale | 1 | (A) | 1 (A) | 2 (A) | 2 (A) | 3 | (A) |
| 32 lb Laser jet | 0 | .5 | (A) | 1 (A) | 1 (A) | 1 (A) | 2 | (A) |
| 21 lb Multi-purpose | 0 | 1 | (A) | 2 (A) | 3 (A) | 4 (A) | 4.5 | (AU) |
| 20 lb Food-grade, standard | 0 | 1.5 | (A) | 2 (A) | 3 (A) | 4 (A) | 5 | (U) |
| (tm) | | | | | | | | |
| OTHER TYPES OF PAPER | | | | | | | | |
| Toilet paper, Nice n' Soft | 0 Scale | 4 | (A) | 7 (U) | 8 (U) | 8 (U) | 9 | (U) |
| (tm, u) | | | | | | | | |
| Card stock, premium (tm, u) | 0 | 3 | (A) | 4 (A) | 6 (U) | 7 (U) | 8 | (U) |
| Handi Wipe- web woven | 0 | 3 | (A) | 5 (U) | 6 (U) | 7 (U) | 8 | (U) |
| fabric (u) | | | | | | | | |
| Paper towel, Brawny (u) | 0 | 2 | (A) | 4 (A) | 5 (U) | 6 (U) | 7 | (U) |

| | | | | | | |
|---|---|---|---|---|---|---|
| Card board, backing (fe) | 0 | NA | — | — | — | — |

Table 1.4 and 1.6 show distinct differences in capabilities of different paper types and proves that paper cannot be generalized as just paper it must be stated as to what specific type, for example: unable to prevent tearing during application, unable to prevent tearing during manufacturing, unable to remove, stuck to fruit, unable to keep on fruit, fell off, ugly appearance, and manufacturing process significantly changed the paper's facade. Specific to this invention, acceptable score results fell best within the 32 lb range. Concluding that for the specifics of this invention a preservative paper of wt 25-40 lb or 90-150 grams per sq. meter uncoated, acid-free, laser printing paper, with bond strength of an interlayer binding force, soaked in acid constituents, for at least fifteen (15) minutes and then dried for at least one (1) hour prior to use for applying to exposed or cut surfaces of fruit or vegetables is a necessary formula and that the paper type is not an obvious choice and cannot be described as just “paper.”

1. A preservative paper weighing 25-40 lbs or 90-150 grams per sq. meter uncoated, acid-free, laser printing paper, with bond strength of an interlayer binding force, soaked for more than five (5) minutes in a sufficient acid constituent consisting of one-hundred percent (100%) citric juice concentrate and then dried for one (1) hour prior to use.

2. A preservative paper weighing 25-40 lbs or 90-150 grams per sq. meter uncoated, acid-free, laser printing paper, with bond strength of an interlayer binding force, soaked for more than five (5) minutes in a sufficient acid constituent consisting of one-hundred percent (100%) ascorbic acid (vitamin C) and water, and then dried for one (1) hour prior to use.

3. A preservative paper weighing 25-40 lbs or 90-150 grams per sq. meter uncoated, acid-free, laser printing paper, with bond strength of an interlayer binding force, soaked for more than five (5) minutes in a sufficient acid constituent consisting of one-hundred percent (100%) citric juice concentrate and one-hundred percent (100%) ascorbic acid (vitamin C) and water, and then dried for one (1) hour prior to use.

4. A preservative paper according to claim 18, cut into the most preferred lengths and widths for fruit such as apples, pears, bananas and other fruits or vegetables that discolor, lose flavor and/or nutrients after cutting.

5. A preservative paper according to claim 19, cut into the most preferred lengths and widths for fruit such as apples, pears, bananas and other fruits or vegetables that discolor, lose flavor and/or nutrients after cutting.

6. A preservative paper according to claim 20, cut into the most preferred lengths and widths for fruit such as apples, pears, bananas and other fruits or vegetables that discolor, lose flavor and/or nutrients after cutting.

7. A preservative paper according to claim 18, cut into convenient lengths and widths dispensed from a container such as a pop-top box dispenser or other container for consumer use.

8. A preservative paper according to claim 19, cut into convenient lengths and widths dispensed from a container such as a pop-top box dispenser or other container for consumer use.

9. A preservative paper according to claim 20, cut into convenient lengths and widths dispensed from a container such as a pop-top box dispenser or other container for consumer use.

10. A preservative paper according to claim 18, wherein the most preferred lengths and widths are lengths of 1″-12″ and in widths of 1″-12″.

11. A preservative paper according to claim 19, wherein the most preferred lengths and widths are lengths of 1″-12″ and in widths of 1″-12″.

12. A preservative paper according to claim 20, wherein the most preferred lengths and widths are lengths of 1″-12″ and in widths of 1″-12″.

13. A preservative paper according to claim 18, wherein the preservative paper is manufactured in rolls for distribution in lengths of up to one-hundred thousand (100,000) feet, in widths of 1″-500″ that can be measured and cut into shorter, customized-lengths and widths, as needed.

14. A preservative paper according to claim 19, wherein the preservative paper is manufactured in rolls for distribution in lengths of up to one-hundred thousand (100,000) feet, in widths of 1″-500″ that can be measured and cut into shorter, customized-lengths and widths, as needed.

15. A preservative paper according to claim 20, wherein the preservative paper is manufactured in rolls for distribution in lengths of up to one-hundred thousand (100,000) feet, in widths of 1″-500″ that can be measured and cut into shorter, customized-lengths and widths, as needed.

16. A method according to claim 18, wherein the coated paper comes in a variety of colors.

17. A method according to claim 19, wherein the coated paper comes in a variety of colors.

18. A method according to claim 20, wherein the coated paper comes in a variety of colors.

19. A preservative paper according to claim 18, wherein the paper further comprises of sufficient acid constituents

20. A preservative paper according to claim 19, wherein the paper further comprises of sufficient acid constituents

21. A preservative paper according to claim 20, wherein the paper further comprises of sufficient acid constituents

22. A preservative paper according to claim 18, also comprises of the preservative agents; sodium benzoate, sodium metabisulfite and sodium sulfite, proportions regulated by the food and drug administrative based on pounds per one-thousand (1000) gallon batch.

23. A preservative paper according to claim 19, also comprises of the preservative agents; sodium benzoate, sodium metabisulfite and sodium sulfite, proportions regulated by the food and drug administrative based on pounds per one-thousand (1000) gallon batch.

24. A preservative paper according to claim 20, also comprises of the preservative agents; sodium benzoate, sodium metabisulfite and sodium sulfite, proportions regulated by the food and drug administrative based on pounds per one-thousand (1000) gallon batch.

25. The sufficient acid constituents according to claim 18, whereas the one-hundred percent (100%) citric juice is comprised from one or more combinations thereof, of these five (6) citric groups: orange, lemon, lime, grapefruit, pineapple, mandarin and tangerine.

26. A preservative paper comprising of 24-40 lb wt. or 90-150 grams per sq. meter, uncoated, acid-free, food-grade specialty paper, with bond strength of an interlayer binding force and having sufficient acid constituents to establish and maintain on the exposed surfaces of fruit less than three percent (3%) oxygen to enhance the anti-browning activity.

27. A preservative paper comprising of 25-40 lb wt. or 90-150 grams per sq. meter, uncoated, acid-free, laser printing paper with bond strength of an interlayer binding force, manufactured without micro-biocides and having a sufficient acid constituents to establish and maintain on the exposed surfaces of fruit less than three percent (3%) oxygen to enhance the anti-browning activity.

28. A preservative paper according to claim 43, acid constituents are comprised of ascorbic acid.

29. A preservative paper according to claim 44, acid constituents are comprised of ascorbic acid.

30. A preservative paper according to claim 43, acid constituents are comprised of citric acid.

31. A preservative paper according to claim 44, acid constituents are comprised of citric acid.

32. A preservative paper according to claim 43, acid constituents are comprised of a combination of ascorbic acid and citric acid.

33. A preservative paper according to claim 44, acid constituents are comprised of a combination of ascorbic acid and citric acid.

34. A preservative paper according to claim 43, wherein acid constituents are a food-grade acid constituent.

35. A preservative paper according to claim 44, wherein acid constituents are a food-grade acid constituent.

36. A preservative paper according to claims 43, may also comprise of the following preservative agents: sodium benzoate, sodium metabisulfite and sodium sulfite, proportions regulated by the food and drug administrative based on pounds per one-thousand (1000) gallon batch.

37. A preservative paper according to claim 44, may also comprise of the following preservative agents: sodium benzoate, sodium metabisulfite and sodium sulfite, proportions regulated by the food and drug administrative based on pounds per one-thousand (1000) gallon batch.
